(19) United States
(12) Patent Application Publication
(10) Pub. No.: US 2013/0011675 A1
(43) Pub. Date: Jan. 10, 2013

(54) METHOD FOR PRODUCING POLYSILANE-POLYCARBOSILANE HAVING REDUCED CARBON CONTENT AND FIBERS PRODUCED THEREFROM

(76) Inventors: Juergen Clade, Wuerzburg (DE); Arne Ruedinger, Rottendorf (DE); Dieter Sporn, Wuerzburg (DE)

(21) Appl. No.: 13/512,547

(22) PCT Filed: Nov. 22, 2010
(86) PCT No.: PCT/US2010/067954

§ 371 Date: May 29, 2012

(30) Foreign Application Priority Data
Nov. 30, 2009 (DE) 10 2009 056 371.7

(51) Int. Cl. C08L 83/08; B29B 9/12; C01B 31/36

(52) U.S. Cl. 428/367; 524/588; 423/345; 264/8

(57) ABSTRACT

The invention relates to a method for producing a polysilane-polycarbosilane copolymer solution from which a ceramic material having a ratio of silicon to carbon in the range of 0.8:1.0 to 1.1:1.0 can be obtained after removal of the solvent and pyrolysis, comprising the following steps: generating a chloric raw polysilane/oligosilane containing hydrocarbon groups by means of disproportioning a methylchlorodisilane or a mixture of a plurality of methylchlorodisilanes of the composition Si₂MeₙCl₆₋ₙ, where n=1-4, wherein the disproportioning takes place by means of a Lewis base as a catalyst, thermally post-cross-linking the raw polysilane/oligosilane into a non-melting polysilane-polycarbosilane copolymer that is soluble in a neutral solvent, and producing said solution by means of dissolving the polysilane-polycarbosilane in a neutral solvent. The invention is characterized in that additional elementary silicon or titanium disilicide is added in one step of said method in a suitable quantity as a powder or in the form of a compound comprising alkyl groups bonded to silicon or to nitrogen, wherein said additive either (a) takes place in that the raw polysilane/oligosilane is generated in the presence of a cross-linking agent, selected from compounds of the formula CI₂R¹Si—R², having a boiling point above 100° C. and where R¹ means chlorine, hydrogen, or an alkyl radical having 1 to 4 carbon atoms, and R² is —SiR³₃, —NH—SiR³, or —N(SiR³)₂, where —R³ has the same meaning as R¹, or (b) takes place in that powdered silicon or titanium silicide is added to the polysilane-polycarbosilane solution. Green fibers or material in other forms can be produced from the copolymer solution, and can in turn be converted into ceramic silicon carbide materials. Said material can also be used for constructing ceramic matrices.

The present invention pertains to polysilane-polycarbosilane copolymers, which are prepared from chlorine-containing silanes by specific heat treatment and have a markedly reduced carbon content. Ceramics prepared by pyrolysis thus can have a silicon to carbon molar ratio of nearly 1:1, i.e., they can be nearly or completely free from free carbon. Ceramics of the stoichiometric composition SiC are substantially more stable in respect to oxidation than ceramics with excess carbon compared to silicon.

Silicon carbide materials are known for their mechanical strength at high temperatures as well as for their resistance to oxidation. They are therefore considered for use for a large number of applications, above all in the form of fibers as reinforcing elements in components that are exposed to high temperatures and/or corrosive media.

Polysilanes were first prepared by Kipping via Wurtz coupling of diphenyldichlorosilane with sodium. Dodecamethylcyclohexasilane was used for the first time by Yajima et al. as a starting material for producing SiC ceramic fibers. The compound must be crosslinked for this purpose in an autoclave with the use of high temperature and overpressure, while a conversion into polycarbosilanes (Kumada rearrangement) takes place. A non-meltable, high-molecular-weight polycarbosilane powder is obtained following extraction of low-molecular-weight components. Solutions of this powder in benzene or xylene can be processed according to the dry spinning method into green fibers, which can be pyrolyzed into SiC ceramic fibers without prior curing. The essential drawback of this method is the complicated synthesis of the starting polymer, which includes the use of alkali metals, reactions in an autoclave and an elaborate extraction process.

The use of high pressures during the crosslinking and conversion into polycarbosilane is eliminated in one variant of this method, which leads to a meltable material. This can be processed according to the melt spinning method into green fibers, but these must then be cured prior to pyrolysis by aging in air at elevated temperature. The resulting ceramic fibers therefore contain several weight percentages of oxygen, which considerably impairs their stability at high temperatures. Both variants of the method were patented, see U.S. Pat. No. 4,100,233.

Furthermore, the synthesis of a phenylmethylpolysilane by Wurtz coupling of a mixture of phenylmethyl and dimethyldichlorosilane and the synthesis of branched polysilanes by Wurtz coupling of R₂SiCl₂/RSiCl₃ mixtures (R=methyl, ethyl or phenyl) are known. The spinning method (melt spinning method) employed for the polymers obtained was studied. Numerous other methods for the synthesis of polycarbosilanes were proposed. Many of these methods are listed in WO 2005/108470.

The disproportionation of disilanes with Lewis bases into mono- and polysilanes was discovered by Wilkins in 1953. The corresponding reaction with methylchlorodisilane mixtures from the Miiller-Rochow synthesis was described by Bluestein as well as by Cooper and Gilbert. Roewer et al. studied the disproportionation of the methylchlorodisilanes Cl₂MeSiSiMeCl₂, Cl₂MeSiSiMe₂Cl and ClMe₂SiSiMe₂Cl both under homogeneous catalysis and heterogeneous catalysis. Nitrogen-containing heterocyclic compounds, above all N-methylimidazole, were used in the former case, and nitrogen-containing heterocyclic compounds or bis(dimethylamino)phoshoryl groups, which were bonded to the surface of a silicate carrier, were used in the latter case. Several oligosilanes could be identified in the product mixture. A thermal aftertreatment of the polysilanes for converting them into polycarbosilanes is disclosed in EP 0 610 809 A1; however, this glass-like product can usually be remelted by a relatively mild heat treatment (up to 220° C.).

The preparation of silicon carbide fibers from the polysilanes thus obtained was described as well, e.g., in EP 668 254 B1. However, since the polysilanes are meltable, the green fibers must be cured with ammonia at elevated temperature prior to the pyrolysis.

Curing is usually necessary for the dimensional stabilization of green fibers obtained from polycarbosilanes by melt spinning in order to render the material non-meltable prior to the pyrolysis. This curing is carried out, as a rule, by treatment with a reactive gas. The curing with air at elevated temperature, which was practiced originally, has the drawback that increased quantity of oxygen is introduced into the fiber, which greatly impairs the high-temperature stability of the fiber (damage to the fibers due to release of gas in the form of CO and/or SiO at high temperatures (T. Shimoo et al., J. Ceram. Soc. Jap., Int. Ed. 102 (1994), p. 952). Attempts have therefore also been made to reduce the quantity of oxygen introduced during the curing of the green fibers. Lipowitz (U.S. Pat. No. 5,051,215) describes the curing of green fibers with NO₂ instead of air; the oxygen uptake decreases now from approx. 10-15 wt. % (air curing) to <7 wt. %. However, a minimum oxygen content of 5-6 wt. % is necessary to avoid sticking in the fiber bundle. The curing by irradiation with high-energy electrons, which was proposed as well, might, in turn, be associated with an unintended introduction of oxygen, which ultimately brings about the curing.

The drawback of the older methods is consequently that, as was explained above, the fibers made of meltable starting materials must be precured by aging in air or by means of ammonia at elevated temperatures, which leads to increased, undesired oxygen contents and other drawbacks. By contrast, even though fibers from non-meltable, high-molecular-weight polycarbosilane powders can be processed from solutions of these powders in benzene or xylene into green fibers according to the dry spinning process and these green fibers can be pyrolyzed into SiC ceramic fibers without preceding curing, the process leading to such non-meltable powders is costly and elaborate.

To eliminate this problem and to arrive at an easily manageable method, a method for producing a polysilane-polycarbosilane copolymer solution, from which ceramic moldings with low oxygen content can be produced, is disclosed in WO 2005/108470. The starting material for this solution is cost-effective and can be obtained in a simple manner and can be converted in a very simple manner into a non-meltable material, which can be converted into the corresponding ceramic material without further treatment after molding.

Said starting material is polysilanes, which can be obtained by disproportionating methylchlorodisilane mixtures, which can be obtained as a high-boiling fraction during the direct synthesis of methylchlorosilanes (Müller-Rochow process (U.S. Pat. No. 2,380,995 (1941); R. Müller, Wiss. Z. Techn. Univ. Dresden 12 (1963), p. 1633), with Lewis base catalysts. A crosslinking aid, selected from among aryl halogen silanes and aryl halogen boranes, is preferably added during this disproportionation. The polysilanes thus obtained (usually called raw polysilanes/oligosilanes) can be modified by means of a subsequent, specific heat treatment easily such that even though they are hard to melt or non-meltable, they are still soluble in indifferent solvents to such an extent that they can be subjected to further processing in a molding process. Solutions of these materials can be used, e.g., to prepare fibers according to the dry spinning method or to construct ceramic matrices according to the liquid-phase infiltration method. Polymer fibers that can be obtained from these solutions can be pyrolyzed in the bundle into SiC ceramic fibers without sticking together without further shape-stabilizing treatment.

However, the drawback of these materials is that their carbon content is relatively high because of the addition of carbon-containing crosslinking agents during the preparation: If they are pyrolyzed, ceramics with a silicon to carbon ratio in the range of approx. 2:3 are obtained. However, if n-octyltrichlorosilane is used as the crosslinking agent, as it is used, for example, in DE 37 43 373, the octyl radical is split off during the pyrolysis, as a result of which a product with a lower carbon content is obtained, even though it is porous.

The object of the present invention is to provide a method for producing low-oxygen or oxygen-free, polysilane-containing polymers in a good yield, which can be pyrolyzed into dense ceramics with a silicon to carbon ratio in the range of 0.8:1.0 to 1.1:1.0. This corresponds to an Si content of 44.4 at. % to 52.4 at. % relative to the sum of carbon and silicon. The same starting materials that are indicated in WO 2005/108470 shall be used, because these are cost-effective educts that can be easily obtained.

The object is accomplished by the suggestion to additionally add elementary silicon or titanium silicide in a powdered form or a compound that contains alkyl groups bound to silicon or to nitrogen in one of the steps of this method.

The present invention can be embodied in two embodiments:

In one embodiment, a crosslinking aid according to formula (I)

Cl₂R¹S¹—R² (I)

which has a boiling point above 100° C. and in which R¹ denotes chlorine, hydrogen or an alkyl radical containing 1 to 4 carbon atoms and R² denotes —SiR³₃, —NH—SiR³₃ or —N(SiR³₃)₂, in which R³ has the same meaning as R¹, is added during the preparation of the raw polysilanes/oligosilanes, which is otherwise carried out according to the teaching of WO 2005/108470. Mixtures of these substances with one another or with aryl halogen silanes or boranes such as phenyltrichlorosilane, diphenyldichlorosilane or phenyldichloroborane are also possible, provided that the percentage of crosslinking aid according to formula (I) is at least 5 mol. %. relative to the sum of methylchlorodisilane, Lewis base and crosslinking aid.

In fact, it was surprisingly found that alkyl groups of a crosslinking agent, which are bonded to silicon or nitrogen atoms, remain in the ceramic during pyrolysis, so that a dense product is obtained.

An alternative approach to accomplishing the object is to add so much powdered silicon or titanium silicide to a polysilane-polycarbosilane copolymer solution prepared according to WO 2005/108470 that the carbon excess is reacted to silicon carbide and possibly titanium carbide at high temperatures.

In fact, a dense product can surprisingly also be obtained in this manner, because the carbon formed during the high-temperature treatment reacts to form silicon carbide and possibly additionally titanium carbide. Other powdered, silicon-containing materials, such as SiO₂ or Si₃N₄, have, by contrast, proved to be less suitable, because they are reacted with carbon to form SiC and CO in the former case and SiC and N₂ in the latter case. The gaseous products CO and N₂ released in the process cause, in turn, the ceramic formed to become porous.

In a preferred variant of this embodiment, the powdered silicon or titanium silicide is hydropobized on its surface before being added to the copolymer solution, e.g., by replacing the hydroxyl groups present on the surface with trimethylsilyl ether surface groups by boiling with trimethylchlorosilane (according to EP 0378785) or the like, because it was found that the rheological properties of the polymer-silicon or polymer-titanium disilicide mixture, which are relevant, e.g., for fiber spinning, are markedly improved by this measure.

Consequently, the same silanes/oligosilanes containing chlorine and hydrocarbon groups are used as starting material for preparing the polymer as those that are also indicated as the starting material in WO 2005/108470 A1. These are mixtures of methylchlorodisilanes of the composition Si₂MeₙCl₆₋ₙ, (n=1-4), and preferably those that are obtained as a high-boiling fraction (bp. 150-155° C.) during the “direct synthesis” according to Rochow and Müller. The latter consist, as a rule, of a mixture of 1,1,2,2-tetrachlorodimethyldisilane and 1,1,2-trichlorotrimethyldisilane with less than 10 mol. % of other components. The two disilanes mentioned are preferably charged in in advance at a molar ratio ranging from 0.5:1 to 1.5:1.

Said disilane mixtures are disproportionated according to, e.g., EP 610809 or U. Herzog et al., Organomet. Chem., 507 (1996), p. 221 under homogeneous catalysis with a nitrogen-containing Lewis base and—in the first embodiment of the present invention—in the presence of the above-mentioned crosslinking aid according to formula (I), preferably at elevated temperature, and the monosilane mixtures obtained as cleavage products during the reaction are distilled off continuously. The reaction temperature is preferably 150-300° C. and more preferably 180-250° C. An organic nitrogen compound with Lewis basicity but without N—H— functional group is used as the catalyst. Nitrogen-containing heterocyclic compounds such as pyridine, quinoline, N-methylpiperidine, N-methylpyrrolidine, N-methylindole or N-methylimidazole are preferred catalysts. N-Methylimidazole is especially preferred. The quantity of catalyst used is preferably 1 wt. % to 2 wt. %. 1,1,1-trichlorotrimethyldisilazane is highly favorable as a crosslinking aid; the percentage of this aid or of another crosslinking aid according to formula (I) is preferably 5 wt. % to 20 wt. % and more preferably 10 wt. % to 15 wt. %. The disproportionation is otherwise carried out under the conditions known from the literature; it is especially favorable to keep moisture and oxygen away from the materials by using inert gas such as ultrapure nitrogen gas, because the product is sensitive to hydrolysis and oxygen.

Another crosslinking aid, selected from among aryl halogen silanes and aryl halogen boranes and especially from among phenyltrichlorosilane, diphenyldichlorosilane and phenyldichlorosilane, may optionally be present, and the percentage of this aid shall not exceed 5 mol. % relative to the sum of methylchlorodisilane, Lewis base and crosslinking aid.

In a special embodiment, the chlorine content in the polysilane/oligosilane thus obtained can be lowered. This is preferably carried out by chlorine substitution in a next step. Chlorine is replaced in this substitution with a nitrogen-containing, chlorine-free substituent, preferably by means of amine and/or silylamine compounds as substituting agents, i.e., compounds that contain at least one N—Si— group and more preferably at least one N—H— group. In a first variant of this preferred embodiment, these are preferably selected from among ammonia and primary or secondary amines. Suitable are especially amines according to formula HNR¹R², in which R¹ and R² are, independently from one another, hydrogen, optionally alkyl, alkenyl, aryl, arylalkyl, alkylaryl, arylalkenyl, alkenylaryl or (R³₃)Si—[NR³—Si(R³)₂]ₘ optionally substituted with additional amino groups, in which m=0 to 6, or in which R¹ and R² together represent an alkylene radical containing 4 or 5 carbon atoms or —Si)R³)₂—[NR³—Si(R³)₂]ₙ, in which n=1 to 6. Silylamines, especially silazanes according to formula Si(R³)₃-[NR³—Si(R³)₂]ₙ—R³, in which n may be an integer from 1 to 6, are used in a second variant. Radical R³ is equal or different and denotes hydrogen, alkyl or aryl in all cases. The compounds are secondary, cyclic amines, selected especially from among pyrrole, indole, carbazole, pyrazole, piperidine and imidazole, in a third, preferred variant. The substitution is carried out in a fourth variant with a compound according to formula N(R⁴)₃, in which R⁴ has the meaning (R³)₃Si.

The number of amino groups in R¹ and R² is not limited, but it is preferably 0 to 6 and more preferably 0 to 4. The number of carbon atoms in R¹, R² and R³ is likewise not limited, but it is preferably 1 to 6 for aliphatic radicals and 5 to 20 for aromatic and aliphatic-aromatic radicals.

The amines are selected more preferably from among ammonia, ethylenediamine, diethylamine, dimethylamine, methylamine, aniline, ethylamine, hexamethyldisilazane, heptamethyldisilazane and tris-(trimethylsilyl)amine. Especially preferred are amines among the above-mentioned ones that carry short-chain alkyl radicals, especially methyl and ethyl radicals. Dimethylamine is especially favorable. Secondary amines have the advantage that the polymers obtained with them carry —NR₂ groups, i.e., are free from NH— functional groups. The advantage is that polycondensation of amino groups, which could lead to more poorly soluble or no longer soluble products, which is not, of course, desired according to the present invention, is impossible during the subsequent crosslinking of such polysilanes/oligosilanes substituted in this manner. Nevertheless, silylamines such as disilazanes are likewise suitable instead of pure amines, because the introduction of silicon atoms during the substitution does not lead to disadvantageous effects for the later moldings or fibers. The substitution with silylamines has, moreover, the advantage that the chlorine is not obtained in the form of an ammonium salt, but in the form of trimethylchlorosilane, which can be removed by distillation and returned into the process chain.

The chlorine reduction/substitution is carried out, as a rule, as follows:

The starting material, i.e., the raw polysilane/oligosilane, which carries/contains hydrocarbon groups and is obtained by the above-described disproportionation, is dissolved in a suitable inert and aprotic solvent. Mainly aprotic, nonpolar solvents, such as aliphatic hydrocarbons (e.g., n-pentane, n-hexane, cyclohexane, n-heptane, n-octane), halogenated hydrocarbons (e.g., methylene chloride, chloroform, carbon tetrachloride, 1,1,1-trichloroethane, chlorobenzene) or aromatic hydrocarbons (e.g., benzene, toluene, o-xylene, sym.-mesitylene), as well as ether-like solvents (e.g., diethyl ether, diisopropyl ether, tetrahydrofuran, 1,4-dioxane or a higher or non-symmetrical ether) may be used as solvents. The solvent is preferably a halogen-free hydrocarbon, especially preferably an aromatic hydrocarbon from the group comprising benzene, toluene and o-xylene.

The substituting agent (amine) is added in a molar excess, which is preferably at least 2:1, relative to the bonded chlorine atom in the starting material. The substituting agent is added undiluted or dissolved in an inert and aprotic solvent as described above. The addition may be performed, e.g., by dropwise addition; a temperature between room temperature and the boiling point of the amine or of the solution thereof should preferably be maintained in the process. A salt which is insoluble in the solvent, or—in case of substitution with silylamines—trimethylchlorosilane is formed during or after the dropwise addition. The suspension is allowed to stand for some time, often for several hours, or boiled under reflux until the solvent reaches its boiling heat. It is subsequently optionally cooled to room temperature, and if a salt has formed, this is filtered off. The solvent as well as the trimethylchlorosilane that may have possibly formed are then removed completely, for example, under vacuum.

In case of using an amine, which is present in the gaseous form during the addition to the raw polysilane/oligosilane, e.g., when using ammonia, this may be introduced as a gas or it may either be condensed into a reaction vessel at temperatures below its boiling point or filled into said reaction vessel as a liquid under overpressure, in case of diluted amines optionally after dilution with a suitable solvent as indicated above. The starting material, dissolved again possibly in the same solvent, is subsequently added. After addition of the total quantity, the batch is allowed to stand for a time period similar to that described above or boiled under reflux and then processed as described above.

The chlorine content in the starting material thus treated can be reduced by the process step according to the present invention to at least no more than 3 wt. %, mostly below 1 wt. % and usually to less than 0.2 wt. %.

The raw polysilane/oligosilane is then subjected, as is described in WO 2005/108470, to a further heat treatment, during which it is made, on the one hand, less meltable or non-meltable by increasing the mean molecular weight, and, on the other hand, it is converted into a polysilane-polycarbosilane copolymer by the rearrangement reactions taking place now. Another effect of this thermal aftertreatment, which is intended according to the present invention, is another reduction of the chemically bound chlorine content should the preceding substitution not have taken place quantitatively.

The thermal aftertreatment usually takes place under atmospheric pressure, and it is highly recommendable to work in the absence of moisture and oxygen. The material is therefore favorably treated under inert gas, especially advantageously under ultrapure nitrogen atmosphere, while the temperature is allowed to rise to between 250° C. and 500° C., preferably to between 300° C. and 450° C. and especially preferably to between 300° C. and 350° C. Heating is preferably carried out continuously at a rate of 1-5 K/minute and preferably 2-4 K/minute. Low-molecular-weight methylsilylamines and partly methylchlorosilylamines formed as cleavage products during the reaction are distilled continuously. The end product of the thermal aftertreatment becomes noticeable from a steep increase in the torque of the stirrer. Last residues of volatile components can be removed under vacuum in a temperature range around 100° C. during the subsequent phase of cooling. The non-meltable, but soluble copolymer according to the present invention can thus be prepared in a single step from the dechlorinated raw polysilane/oligosilane, and no further separation steps (extractions, filtrations) are usually necessary. A polysilane-polycarbosilane solution according to the present invention is obtained by dissolving this copolymer in an indifferent solvent.

If fibers are to be spun or other moldings are to be formed from the polysilane-polycarbosilane copolymer prepared according to the present invention, the copolymer is dissolved in an indifferent organic solvent, as is known from WO 2005/108470. Mainly nonpolar solvents, such as aliphatic hydrocarbons (e.g., n-pentane, n-hexane, cyclohexane, n-heptane, n-octane), aromatic hydrocarbons (e.g., benzene, toluene, o-xylene, sym.-mesitylene), halogenated hydrocarbons (e.g., methylene chloride, chloroform, carbon tetrachloride, 1,1,1-trichloroethane, chlorobenzene) or ethers (e.g., diethyl ether, diisopropyl ether, tetrahydrofuran, 1,4-dioxane or a higher or non-symmetrical ether) may be considered for use as solvent. The solvent is preferably a halogenated or halogen-free hydrocarbons, especially preferably a halogen-free aromatic hydrocarbon from the group comprising benzene, toluene and o-xylene.

The percentage of the polysilane-polycarbosilane copolymer in the polymer solution may be set depending on the intended use of the solution. If the solution is used to prepare fibers according to the dry spinning method, the percentages of the polymers are advantageously 50-90 wt. % and preferably 60-75 wt. %. If the solution is used to construct ceramic matrices according to the liquid-phase infiltration method, the percentage of polymer may be selected to be markedly lower, e.g., 20 wt. %, based on the low viscosity needed.

The second embodiment of the present invention is limited to variants in which the polysilane-polycarbonate copolymer is dissolved and the presence of solids in the solution causes no problems, e.g., if the solution is to be spun into fibers, as was mentioned farther above. Rather than a compound according to formula (I), the crosslinking aids known from WO 2005/108470 (an aryl halogen silane, an aryl halogen borane or a mixture of the two, and especially aryl chlorosilanes, such as phenyltrichlorosilane and/or aryl chloroboranes, such as phenyldichloroborane) are used as crosslinking aids during the disproportionation of the methylchlorodisilanes in this embodiment. The further process steps are then carried out as described above for the first variant, i.e., with or without chlorine reduction. The non-meltable, but soluble copolymer thus obtained is finally dissolved in an indifferent solvent such as toluene. Powdered silicon and/or titanium disilicide (usually with a particle diameter of about 1-2 μm), which was preferably hydrophobized as described above in order to prevent sedimentation of the added particles and to maintain them in suspension, is added to the solution. The percentage of silicon or titanium disilicide powder is calculated such that the carbon excess is converted into silicon carbide and possibly titanium carbide during the subsequent high-temperature treatment, so that the (Si+Ti):C ratio of the resulting ceramic is between 0.8:1.0 and 1.1:1.0. The quantity of powder used for this is preferably 20-60 wt. % and more preferably 35-50 wt. % relative to the copolymer used. The (spinning) solution thus obtained has a consistency suitable for spinning or for other processing methods as well as flow properties that are likewise suitable for this.

The polysilane-polycarbosilane copolymer solution according to the present invention is generally suitable for producing ceramic silicon carbide materials with a silicon to carbon ratio in the range of 0.8:1.0 to 1.1:1.0. The polysilane-polycarbosilane is converted for this from said solution into the desired form. Unless the solvent had already been distilled before, it is removed, and the remaining material is pyrolyzed under an inert gas atmosphere or reducing atmosphere.

The preparation of SiC ceramic fibers from the polymer solutions according to the present invention will be specifically described below without this being considered a limitation of the possible applications of this solution.

Polymer fibers are prepared according to the dry spinning method; this is state of the art (F. Foumé: Synthetische Fasern [Synthetic Fibers], Carl Hauser Verlag, 1995, p. 183; V. B. Gupta, V. K. Kothari (editors): Manufactured Fiber Technology, Chapman & Hall, 1997, p. 126). Preferred parameters for the spinning process are the use of a set of nozzles with nozzles of a diameter of 50 to 300 μm and a capillary length of 0.2 mm to 0.5 mm, a shaft temperature of 20° C. to 50° C. at a length of 2 m and a pull-off velocity of 100 m/minute to 300 m/minute.

The polymer fibers according to the present invention can be pyrolyzed without preceding shape-stabilizing treatment. The preferred parameters for the pyrolysis are a heat-up rate between 5 K/minute and 50 K/minute and a final temperature of 900° C. to 1,200° C. The pyrolysis may be carried out under inert (N₂, argon) or reducing (argon/H₂, N₂/CO, etc.) atmosphere. The preferred atmosphere for the pyrolysis is nitrogen or forming gas (argon with 10 vol. % of H₂). For example, an electric furnace is suitable for use as a furnace.

After pyrolysis, the ceramic fibers may be subjected to a further heat treatment, which leads to their compaction and partial or complete crystallization and improves their mechanical strength.

The heat treatment is preferably carried out at temperatures between 1,500° C. and 2,200° C. and more preferably between 1,700° C. and 1,900° C.

In case of producing materials in a form other than in the form of fibers, the pyrolysis and/or optionally the heat treatment may be carried out under the same conditions as was described above for the fibers.

The present invention will be described and illustrated in more detail by the following examples, but these examples cannot be considered to represent a limitation to the field of application.

### EXAMPLE 1

According to EP 502399, 255.4 g of hexamethylene disilazanes are mixed with 222.0 g of silicon tetrachloride, and the mixture is stirred for 10 hours at 60° C. The subsequent fractionating distillation under vacuum yields 135 g of pure 1,1,1-trichlorotrimethyldisilazane. Another fraction, which contains 1,1,1,3,3-pentachloro-trimethyltrisilazane as a high-boiling compound, can be processed by a further fractionating distillation.

### EXAMPLE 2

### Preparation of a Raw Polysilane/Oligosilane

1,000 g of a methylchlorodisilane mixture (“disilane fraction” from the Miiller-Rochow process, consisting of 45 mol. % of Cl₂MeSiSiMeCl₂ and Cl₂MeSiSiMe₂Cl each as well as 10 mol. % of ClMe₂SiSiMe₂Cl, mp. 150-155° C.) are mixed with 25 g of N-methylimidazole and 100 g of 1,1,1-trichloro-trimethyldisilazane as a crosslinking aid and heated to 180° C. at a rate of 0.5 K/minute. Approx. 450 mL of a distillate, which consists of MeSiCl₃, Me₂SiCl₂ and Me₂ClSiSiMe₂Cl, as well as 153 g of a dark brown raw polysilane/oligosilane with a chlorine content of about 30 wt. %, which is solid at room temperature and is sensitive to hydrolysis, are now obtained. This is dissolved in toluene or xylene to obtain a solution containing 60 wt. % of raw polysilane/oligosilane.

### COMPARISON EXAMPLE 1

Example 2 was repeated, but phenyltrichlorosilane was used instead of 1,1,1-trichloro-trimethyldisilazane.

### EXAMPLE 2

### sic, Example 3—Tr. Ed

### Modification of a Raw Polysilane/Oligosilane with Liquid Methylamine

100 mL of toluene or xylene are charged in advance into a 1-L double-walled, three-neck flask with reflux cooler, dripping funnel and KPG stirrer; the double-walled flask is cooled to −30° C. by means of a cryostat. Approx. 300 mL of methylamine are condensed, and 275 g of a 60% solution of the raw polysilane/oligosilane according to Example 2 in toluene or xylene are subsequently added dropwise via a dripping funnel. The methylammonium chloride separated after thawing is filtered off by means of a pressure nutsche and the solvent is removed from the filtrate under vacuum at 65° C. The modified polysilane/oligosilane obtained contains less than 0.2 wt. % of chlorine (lower detection limit).

### EXAMPLE 4

### Modification of a Raw Polysilane/Oligosilane with Liquid Dimethylamine

The modification is carried out analogously to that described in Example 3, but with the use of dimethylamine instead of methylamine. The modified polysilane/oligosilane contains at most 0.2 wt. % of chlorine (lower detection limit).

### EXAMPLE 5

### Modification of a Raw Polysilane/Oligosilane with Gaseous Dimethylamine

1.5 L of a 60-wt. % solution of a raw polysilane/oligosilane according to Example 2 in toluene or xylene are charged in advance into a double-walled vessel and cooled to 0° C. by means of a cryostat. A slow stream of gaseous dimethylamine is admitted below the liquid level via a submerged tube. The volume flow is to be adjusted such that the gas is completely absorbed on entry into the liquid; the contents of the reaction vessel are to be stirred vigorously. The temperature is measured by means of an internal thermometer during the reaction; the dimethylamine consumption is monitored by means of a balance. The reaction is stopped after introducing the theoretically necessary quantity of dimethylamine; the end can also be recognized from a reduction of the internal temperature. The reaction mixture is filtered off via a pressure nutsche and the solvent is removed from the filtrate under vacuum at 65° C. The modified polysilane/oligosilane obtained contains less than 0.2 wt. % of chlorine (lower detection limit).

### COMPARISON EXAMPLE 2

Example 5 was repeated, but with the use of 1.5 L of a 60-wt. % solution of the raw polysilane/oligosilane according to Comparison Example 1.

### EXAMPLE 6

### Preparation of a Polysilane-Polycarbosilane Copolymer by Thermal Crosslinking

One hundred fifty-one g of a polysilane according to Example 2 are heated in a round-bottomed flask to 400° C. at a rate of 3 K/minute and maintained at this temperature for 50 minutes. The temperature is maintained at 100° C. for 1 hour during the subsequent cooling and the last residues of volatile components are drawn off at the same time by applying vacuum. 16 mL of a yellow distillate, consisting of different mono-, di- and oligomethylchlorosilanes, as well as 108.5 g of a dark brown polysilane-polycarbosilane copolymer are obtained.

### COMPARISON EXAMPLE 3

Example 6 was repeated, but the polysilane according to Comparison Example 1 was crosslinked thermally.

### EXAMPLE 7

### Thermal Crosslinking of a Polysilane/Oligosilane Modified with Dimethylamine

Six hundred g of the modified polysilane/oligosilane from Example 5 are slowly heated to a final temperature of approx. 330° C. in a distillation apparatus. Approx. 200 mL of a yellowish distillate, which consists essentially of different dimethylamino-methylmonosilanes, are obtained during the heating; the end point of crosslinking can be recognized from the solidification of the mass. After cooling, the copolymer obtained, whose chlorine content is only about 0.5 wt. % now, is obtained in toluene or xylene to obtain an approx. 70-wt. % solution. The solution has a suitable viscosity (approx. 20-40 Pas) to be spun into fibers according to Patent Application DE 10 2004 04 531 A1.

### EXAMPLE 8

### Thermal Crosslinking of a Polysilane/Oligosilane Modified with Dimethylamine and Preparation of a Spinning Compound Filled with Silicon Powder Therefrom

Surface modification of silicon powder: 500 g of silicon powder with an average particle size of <5 μm were refluxed in 500 mL of trimethylchlorosilane for 1 hour, filtered over a pressure nutsche, washed with dry n-pentane, and dried under vacuum.

Six hundred g of the modified polysilane/oligosilane from Comparison Example 2 were subjected to thermal crosslinking according to the data from Example 7. An approx. 65-wt. % solution in toluene is prepared from the solid copolymer thus obtained, whose chlorine content is only about 0.5 wt. % now and mixed with 45 wt. % of the surface-modified silicon powder relative to the crosslinked copolymer used. The solution has a suitable viscosity (approx. 20-40 Pas) to be spun into fibers according to Patent Application DE 10 2004 04 531 A1.

### COMPARISON EXAMPLE 4

### Thermal Crosslinking of a Polysilane/oligosilane Modified with Dimethylamine and Preparation of a Spinning Compound Therefrom

Example 8 is repeated without the addition of surface-modified silicon powder, the quantity of toluene being selected to be such that the solution has a viscosity suitable for spinning.

### EXAMPLE 9

### Preparation of Polysilane-Polycarbosilane-Copolymer Green Fibers

The spinning compound obtained according to Example 7 is filled under inert conditions

(glovebox) into a spinning apparatus, which comprises a feed tank, a spinning pump and a set of nozzles comprising a filter and nozzle plate. The spinning compound is extruded through the nozzles (diameter 100 μm, I/D=2) in the form of a strand. After falling through a shaft heated at 40° C., the polymer filaments are wound up on a galette. The solvent evaporates in the spinning shaft. The drawing can be varied continuously by varying the speed of rotation of the galette and the rate of injection from the spinnerets and the green fiber diameter can thus be set.

### EXAMPLE 10

### Preparation of Polysilane-Polycarbosilane Green Fibers with Silicon Powder

Example 9 is repeated with the use of the spinning compound filled with silicon powder from Example 8.

### COMPARISON EXAMPLE 5

### Preparation of Polysilane-Polycarbosilane Green Fibers without Silicon Powder

Example 9 is repeated, but the spinning compound from Comparison Example 4 is used.

### EXAMPLE 11

### Preparation of SiC Ceramic Fibers

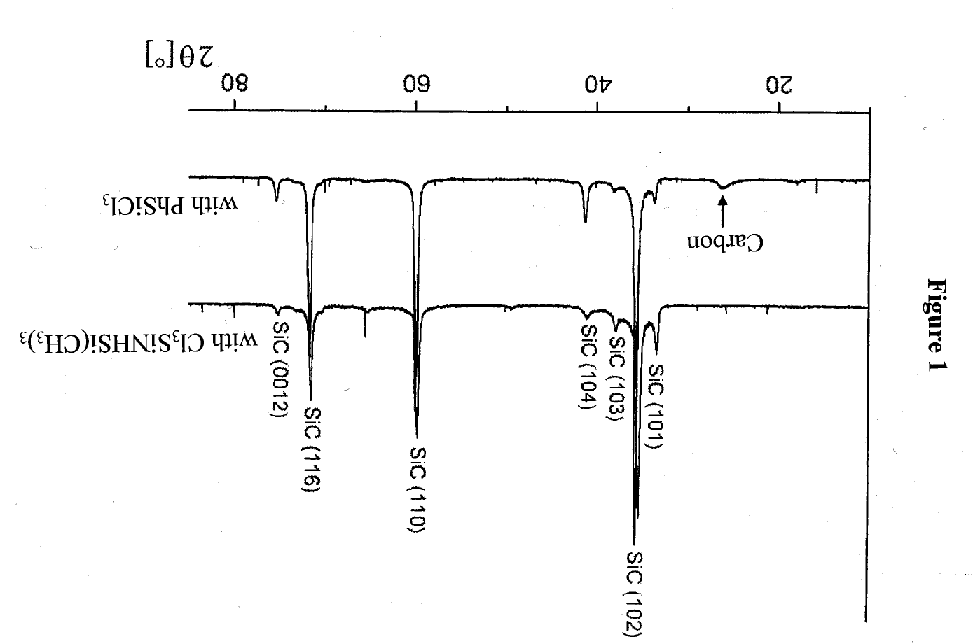

The green fibers prepared according to Example 9 are pyrolyzed up to a final temperature of 1,200° C. at a rate of 12 K/minute in a vertically standing furnace under inert gas atmosphere (N₂). Black, shiny fibers with an oxygen content of less than 1 wt. %, an Si:C ratio of 1.0:1.0, determined by ultimate analysis after corresponding decomposition, a diameter of 10-15 μm, a tensile strength of 1,000-1,500 MPa and a modulus of elasticity of approx. 150-180 GPa are obtained. After sintering the fibers at >2,000° C., the upper X-ray diffractogram in FIG. 1 is obtained. It shows no indication of excess (amorphous) carbon. The ceramic consequently consists exclusively of silicon and carbon.

### EXAMPLE 12

### Preparation of SiC Ceramic Fibers

The green fibers prepared according to Example 10 are pyrolyzed at first as described in Example 11. They are then heated at 1,500° C. for 5 minutes under argon atmosphere. The free carbon in the fibers is caused to react with the silicon powder by this high-temperature treatment, and the resulting ceramic fibers consist exclusively of crystallized silicon carbide (silicon to carbon atomic ratio 1:1).

### COMPARISON EXAMPLE 6

### Preparation of SiC Ceramic Fibers

The green fibers prepared according to Comparison Example 5 are pyrolyzed as described in Example 11. After subsequent sintering at >2,000° C., the ultimate analysis shows Si:C=1.0:1.68. The X-ray powder diffractogram (FIG. 1, bottom) shows the excess carbon.

1. Method for producing a polysilane-polycarbosilane copolymer solution, from which a ceramic material with a silicon to carbon ratio in the range of 0.8:1.0 to 1.1:1.0 can be obtained after removal of the solvent and pyrolysis, comprising the following steps:
preparation of a raw, chlorine-containing polysilane/oligosilane containing hydrocarbon groups by disproportionating a methylchlorodisilane or a mixture of a plurality of methylchlorodisilanes of the composition Si₂MeₙCl₆₋ₙ, in which n=1-4, wherein the disproportionation is carried out with a Lewis base as the catalyst,
thermal post-crosslinking of the raw polysilane/oligosilane into a non-meltable polysilane-polycarbosilane copolymer soluble in indifferent solvents, as well as
preparation of said solution by dissolving the polysilane-polycarbosilane in an indifferent solvent,
characterized in that a suitable quantity of elementary silicon or titanium disilicide as a powder or a compound that contains alkyl groups bonded to silicon or nitrogen is added in one step of this method, wherein this addition is carried out either
(a) by producing the raw polysilane/oligosilane in the presence of a crosslinking aid selected from among compounds according to formula (I)
Cl₂R¹S¹—R² (I)
which have a boiling point above 100° C. and in which R¹ denotes chlorine, hydrogen or an alkyl radical containing 1 to 4 carbon atoms and R² is —SiR³₃, —NH—SiR³₃ or —N(SiR³₃)₂, in which R³ has the same meaning as R¹, or
(b) by adding powdered silicon or titanium disilicide to the polysilane-polycarbosilane solution.

2. Method in accordance with claim 1, variant (b), in which the preparation of the raw polysilane/oligosilane is prepared in the presence of a crosslinking aid selected from among aryl halogen silanes, aryl halogen boranes and mixtures thereof.

3. Method in accordance with claim 1, characterized in that the crosslinking aid is present in a quantity of 5-20 mol. % and preferably 10-15 mol. % relative to the molar sum of methylchlorodisilane, Lewis base and crosslinking aid.

4. Method in accordance with claim 1, wherein the chlorine content in the polysilane-polycarbosilane copolymer is reduced by reacting the raw polysilane/oligosilane or the polysilane-polycarbosilane copolymer with a substituting agent, by which chlorine bonded in same is replaced by a chlorine-free substituent.

5. Method in accordance with claim 4, wherein the substituting agent is selected from among compounds that have an N—H group or an N—Si group, preferably from among ammonia, primary amines, secondary amines and mixtures thereof.

6. Method in accordance with claim 1, characterized in that the thermal post-crosslinking is carried out at temperatures of 250° C. to 500° C.

7. Method in accordance with claim 6, characterized in that a saturated hydrocarbon from the group comprising n-pentane, n-hexane, cyclohexane, n-heptane, n-octane, an aromatic hydrocarbon from the group comprising benzene, toluene, o-xylene, sym.-mesitylene, a chlorinated hydrocarbon from the group comprising methylene chloride, chloroform, carbon tetrachloride, 1,1,1-trichloroethane, chlorobenzene, or an ether from the group comprising diethyl ether, diisopropyl ether, tetrahydrofuran, 1,4-dioxane or a mixture of two or more of these solvents is used as the indifferent solvent.

8. Method for producing green fibers, comprising the steps:
Preparation of a polysilane-polycarbosilane copolymer solution as claimed in claim 1, and
spinning of the dissolved polysilane-polycarbosilane copolymer into green fibers according to the dry spinning method.

9. Method in accordance with claim 8, characterized in that the dry spinning process is carried out at a temperature of 20° C. to 100° C. at a pull-off rate of 20 m/minute to 500 m/minute.

10. Method for producing ceramic silicon carbide materials with a silicon to carbon ratio in the range of 0.8:1.0 to 1.1:1.0, comprising the steps of
preparing a polysilane-polycarbosilane copolymer solution as claimed in claim 1,
converting the polysilane-polycarbosilane copolymer from this solution into a desired form, and
pyrolysis of said copolymer under an inert gas atmosphere or reducing atmosphere.

11. Method in accordance with claim 10, wherein the material is fibers, characterized in that the step of converting the polysilane-polycarbosilane copolymer from the corresponding solution into a desired form comprises the production of green fibers according to the dry spinning method.

12. Method in accordance with claim 10, characterized in that the pyrolysis is carried out at final temperatures of 900° C. to 1,200° C. at a heat-up rate of 1K/minute to 50 K/minute in an inert or reducing atmosphere.

13. Method in accordance with claim 10, characterized in that the ceramic silicon carbide material is sintered after the pyrolysis at temperatures of 1,200-2,000° C. under inert or reducing atmosphere.

14. Low-oxygen silicon carbide ceramic fibers comprising a silicon to carbon ratio in the range of 0.8:1.0 to 1.1:1.0, a fiber diameter between 5 μm and 50 μm and preferably between 10 μm and 15 μm, a tensile strength between 1,000 MPa and 1,500 MPa, and a modulus of elasticity between 150 GPa and 180 GPa.

15. Method for constructing ceramic matrices, comprising the steps of
preparing a chlorine-containing raw polysilane/oligosilane containing hydrocarbon groups by disproportionating a methylchlorodisilane or a mixture of a plurality of methylchlorodisilanes of the composition Si₂MeₙCl₆₋ₙ, in which n=1-4, wherein the disproportionating is carried out with a Lewis base as the catalyst,
thermal post-crosslinking of the raw polysilane/oligosilane into a polysilane-polycarbosilane copolymer,
dissolving the polysilane-polycarbosilane copolymer in an indifferent solvent, and
using the dissolved polysilane-polycarbosilane copolymer to construct a ceramic matrix by liquid-phase infiltration,
characterized in that the raw polysilane/oligosilane is prepared in the presence of a crosslinking aid, selected from among compounds according to formula (I)
Cl₂R¹Si—R² (I)
which have a boiling point above 100° C. and in which R¹ designates chlorine, hydrogen or an alkyl radical containing 1 to 4 carbon atoms, and R² is —SiR³₃, —NH—SiR³₃ or —N(SiR³)₂, and in which R³ has the same meaning as R¹.

16. Low-oxygen silicon carbide ceramic fibers comprising a silicon to carbon ratio in the range of 0.8:1.0 to 1.1:1.0, a fiber diameter between 5 μm and 50 μm and preferably between 10 μm and 15 μm, a tensile strength between 1,000 MPa and 1,500 MPa, and a modulus of elasticity between 150 GPa and 180 GPa, said fibers produced according to a method in accordance with claim 11.
